(19) United States
(12) Patent Application Publication
(10) Pub. No.: US 2025/0180097 A1
(43) Pub. Date: Jun. 5, 2025

(54) PLANETARY GEAR UNIT

(71) Applicant: AKTIEBOLAGET SKF, GOTEBORG (SE)

(72) Inventor: Ingo SCHULZ, Gerolzhofen (DE)

(21) Appl. No.: 18/843,776

(22) PCT Filed: Feb. 27, 2023
(86) PCT No.: PCT/EP2023/054807

§ 371 Date: Sep. 4, 2024

(30) Foreign Application Priority Data
Mar. 10, 2022 (DE) 102022202405.2

(51) Int. Cl. F16H 1/28; F16H 57/08

(52) U.S. Cl. CPC F16H 1/28; F16H 57/082

(57) ABSTRACT

A planetary gear unit includes a first ring gear having toothing and a second ring gear having toothing and at least four double planets each having a first gear wheel having toothing and a second gear wheel having toothing, the first gear wheel and the second gear wheel of each double planet being disposed so as to be rotatable about a common shaft. The toothing of each first gear wheel engages in the toothing of the first ring gear, and the toothing of each second gear wheel engages in the toothing of the second ring gear. A number and a size of the double planets is selected such that a predetermined size of an interior space in a center of the planetary gear unit, a predetermined torsional stiffness of the planetary gear unit and/or a predetermined load-bearing capability of the planetary gear unit is provided.

The present invention relates to a planetary gear unit having a first and second ring gear and at least four double planets according to the preamble of patent claim 1.

Planetary gear units can be used in various technical sectors, for example in the field of industrial robots. Cables, wires, tubes or similar which can enable a supply of power or hydraulic fluid or can transmit signals are required for various functions such as, for example a gripper arm. It is currently however a complex matter to route cables, etc., along the planetary gear units.

It is, therefore, the object of the present invention to provide a planetary gear unit which enables a simple and cost-effective feedthrough of cables and similar.

This object is achieved by a planetary gear unit according to patent claim 1.

Such a planetary gear unit has a first and a second ring gear as well as at least four double planets. Each of the double planets has a first and a second gear wheel which are disposed so as to be rotatable about a common shaft. The toothing of the first gear wheel of each double planet engages in the toothing of the first ring gear, and the toothing of the second gear wheel of each double planet engages in the toothing of the second ring gear.

The drive, i.e. an element driven by a shaft, which is provided in a planetary gear unit can be implemented by one of the ring gears, for example, wherein the other ring gear acts as an output. Since the double planets are in each case in contact with the first ring gear by way of one gear wheel and in contact with the second ring gear by way of the other gear wheel, the movement of the ring gear acting as the drive is transmitted to the ring gear acting as the output. However, other combinations are also possible. For example, a planet carrier which is coupled to the double planets and acts as a drive can be provided. In this case, both ring gears can act as an output. A reversed arrangement, i.e. the ring gears as the drive and the planet carrier as the output, is likewise possible. A ring gear can also be fixedly disposed. In this way, 3-shaft gear units in which all shafts can be arbitrarily free, driven for input, driven for output or fixed can be implemented.

In order now to enable cables, wires, tubes and similar to be fed through the planetary gear unit, the number and size of the double planets are adapted in such a way that a predetermined size of an interior space of the planetary gear unit is provided. This means that the double planets are selected in such a way that cables, etc., can be fed through the interior space of the planetary gear unit. Alternatively, the number and size of the double planets can be adapted in such a way that a predetermined torsional stiffness and/or a predetermined load-bearing capability are/is provided. The number and size of the double planets is preferably adapted in such a way that at least two, most preferably all three, of these predefined conditions are met. For example, the number and size of the double planets can be adapted in such a way that a high torsional stiffness and/or load-bearing capability of the planetary gear unit and at the same time sufficient space for feeding through cables, wires and similar is provided. In this way, the planetary gear unit can be optimized with a view to one or a plurality of parameters.

According to one embodiment, the number and size of the double planets is adapted in such a way that the predetermined size of the interior space of the planetary gear unit, the predetermined torsional stiffness and/or the predetermined load-bearing capability are/is maximized and an external diameter of the ring gears is minimized. This can take place in particular by correspondingly adapting the ratio of the internal diameter of the first and of the second ring gear to the number and size of the double planets. By taking into account the external diameter of the ring gears, the available installation space, i.e. the maximum possible external diameter of the planetary gear unit, will also be taken into account. In this way, minor requirements are set in terms of the required installation space of the application, in which the planetary gear unit is used, in addition to the high load-bearing capability, torsional stiffness and space for feeding through cables, etc.

The ratio of the internal diameter of the first and of the second ring gear to the number of double planets is preferably optimized in such a manner that the diameter of the available interior space is sufficiently large to be able to feed through the cables, wires or other lines required in the application.

For this purpose, for example when four double planets are used in a planetary gear unit, said four double planets can in each case be utilized with a diameter of at least 18 teeth×module and with a ring gear diameter of at least 48 teeth×module. If the ring gear diameter is increased to at least 60 teeth×module, the number of double planets can be increased by two to six without increasing the diameter, in particular the module, of the double planets. This procedure increases in particular the flexural stiffness and the torsional stiffness of the gear unit, on the one hand, and the load-bearing capability. Moreover, the gear unit now offers a larger space in the interior of the gear unit, concentrically about the gear unit axis, for feeding through cables or tubes through the gear unit, for example. An increase in the ring gear diameter to at least 76 teeth×module permits the disposal of eight double planets; an increase to at least 92 teeth permits the disposal of ten double planets; and an increase to at least 104 teeth permits the disposal of twelve double planets. With each increase in the tooth count and thus the number of planets, the flexural stiffness and torsional stiffness, the load-bearing capability and the capability for feeding through comparatively large cables and tubes through the gear unit are significantly increased without altering the individual planet in the process.

This correlation also applies, for example, in the case of a double planet tooth count of 31, wherein the ring gear tooth counts for four, six, eight, ten or twelve double planets would in this instance be 80, 100, 120, 140 and 160. Planet tooth counts of more than 31 and an increase in the number of double planets to more than twelve are likewise possible.

The double planets are advantageously identical to one another, and the ring gears can be adapted in terms of their size, depending on the application. The scaling of the planetary gear unit in this instance takes place only by way of the size of the ring gears and the number of double planets.

According to one embodiment, a tube is disposed in the interior space of the planetary gear unit. The longitudinal axis of the tube herein is coaxial with the rotation axis of the ring gears and in particular coincides with the rotation axis of the ring gears. This tube can be a hollow shaft or a sleeve in which lines such as, for example, cables, wires, etc. can be fed through. By using such a tube, the lines can be protected from contact with the toothings of the double planets and thus from damage.

When the toothings of the gear wheels of the planetary gear unit, i.e. the toothings of the double planets and the toothings of the ring gears, engage in one another, play can arise between the toothings. This can be particularly disadvantageous when the gear wheels change their rotation direction, for example perform a forward movement as well as a reverse movement, because the play between the gear wheels can then have the effect that the toothings of the latter impact one another, under certain circumstances unevenly. This can lead to undesirable wear on the gear wheels.

According to a further embodiment, two double planets, disposed adjacent to one another, of the at least four double planets are therefore in each case disposed in such a way that the first gear wheel of a first double planet of the two adjacent double planets is preloaded in the clockwise direction in such a manner that the toothing of the first gear wheel of the first double planet is in contact with the toothing of the first ring gear, and that the second gear wheel of the first double planet is preloaded in the counter-clockwise direction in such a manner that the toothing of the second gear wheel of the first double planet is in contact with the toothing of the second ring gear. Additionally, the first gear wheel of a second double planet of the two adjacent double planets is preloaded in the counter-clockwise direction in such a manner that the toothing of the first gear wheel of the second double planet is in contact with the toothing of the first ring gear, and that the second gear wheel of the second double planet is preloaded in the clockwise direction in such a manner that the toothing of the second gear wheel of the second double planet is in contact with the toothing of the second ring gear.

In this way, the toothings of the gear wheels of the first double planet are (tangentially) preloaded in two different directions, once in the clockwise direction, once in the counter-clockwise direction, in relation to the ring gears. As a result, there is already contact between the toothings of the ring gears and the toothings of the gear wheels of the double planet due to the preload. Additionally, this contact is also maintained during operation due to the preload in different directions, and any play between the toothings is avoided. At the same time, the toothings of the gear wheels of the second double planet are (tangentially) preloaded in a diametrically opposed manner, i.e. once in the counter-clockwise direction and once in the clockwise direction, in relation to the ring gears.

When viewed across the internal circumference of the ring gears, two adjacent double planets are in particular always preloaded in an opposing manner. This leads to a particularly good force distribution of the preload to the ring gears, and thus to a stable assembly.

When the gear wheels of the respective double planets are preloaded, said gear wheels can be fixed in their mutual relative position. This can take place, for example, by welding, soldering/brazing, adhesive bonding, a radial or axial friction fit or a form fit.

According to a further embodiment, the first ring gear and the second ring gear have in each case a helical toothing, wherein the first ring gear and the second ring gear are designed to rotate in a first rotation direction and a second opposite rotation direction, and wherein the toothings of the first and of the second gear wheel of the at least four double planets are in each case a helical toothing, wherein each helical toothing has a first tooth flank and a second tooth flank which opposes the first tooth flank, wherein a surface normal of the first tooth flank is directed in the first rotation direction and a surface normal of the second tooth flank is directed in the second rotation direction.

In order to prevent any play between the toothings of the ring gears and the double planets, according to this embodiment two double planets, disposed adjacent to one another, of the at least four double planets are disposed in each case in such a way that a first force-exerting element exerts a first force in a first direction, so that the first tooth flanks of the helical toothing of the first gear wheel of a first double planet of the two adjacent double planets are in contact with the second tooth flanks of the helical toothing of the first ring gear, and that the second tooth flanks of the helical toothing of the second gear wheel of the first double planet are in contact with the first tooth flanks of the helical toothing of the second ring gear, as a result of which a preload on the ring gears in the first and the second rotation direction is provided. Furthermore, a second force-exerting element exerts a second force in a second direction which is opposed to the first direction, so that the second tooth flanks of the helical toothing of the first gear wheel of a second double planet of the two adjacent double planets are in contact with the first tooth flanks of the helical toothing of the first ring gear, and that the first tooth flanks of the helical toothing of the second gear wheel of the second double planet are in contact with the second tooth flanks of the helical toothing of the second ring gear, as a result of which a preload on the ring gears in the first and the second rotation direction is provided.

Owing to the preload, there is contact between the helical toothings of the ring gears and the helical toothings of the wheels of the double planets already during start-up. Additionally, this contact can be maintained during operation by means of the force-exerting elements in that the preload is maintained, and play in the toothing between the helical toothings can be avoided in this way.

The first gear wheel and the second gear wheel of each double planet are fixed with respect to one another. Owing to this fixing it is possible to exert the first and the second force simultaneously on both gear wheels of the double planets such that the first tooth flanks and the second tooth flanks are in each case in contact with the first or second tooth flanks of the helical toothing of the first and second ring gear, respectively.

The play in the toothing between the two ring gears and the double planets is avoided owing to the use of the preloaded double planets. Due to the preload on the second double planet, which is in the opposite direction to the preload on the first double planet, play in the toothing between the toothings can be avoided and further improved.

According to a further embodiment, a first half of the double planets is preloaded in the first rotation direction, and a second half of the double planets is preloaded in the second rotation direction, wherein the first half and the second half of the double planets are alternately disposed. In this way, the first and the second force and the preload in the first rotation direction and the preload in the second rotation direction can be uniformly distributed and further improved as a result.

According to a further embodiment, the first force and the second force are greater than an axial force which, as a result of the meshing of the helical toothings of the double planets and of the ring gears, is exerted during the rotation. An elastic behaviour of the system can be reduced by such a distribution between the first and the second force and the axial forces. This means that it can be avoided that the double planets move in the first and second direction during the operation of the planetary gear unit. The first force and the second force in the planetary gear unit are preferably identical.

According to a further embodiment, the force-exerting element can be a spring element, a magnetic element and/or a hydraulic element. Any other type of force-exerting element can also be possible.

As already explained above, according to a further embodiment the number of double planets is a multiple of two. As a result, two double planets with a diametrically opposed preload are always present, as a result of which the dissimilar preload is uniformly distributed in a revolving manner. By using four or more double planets, the play between the two ring gears and the double planets and mutual twisting of the ring gears in all rotation directions, i.e. forwards and backwards, can be optimally prevented. Six or more double planets are preferably provided. The load capacity of the planetary gear unit can in particular be increased by a higher number of double planets.

Further advantages and advantageous embodiments are set forth in the description, the drawings and the claims. The combinations of the features set forth in the description and in the drawings herein are in particular purely exemplary, so that the features may also be present individually or in other combinations.

The invention is to be described in more detail hereinbelow on the basis of exemplary embodiments illustrated in the drawings. Here, the exemplary embodiments and the combinations shown in the exemplary embodiments are purely illustrative and are not intended to define the scope of protection of the invention. This scope is defined solely by the appended claims.

In the drawings:

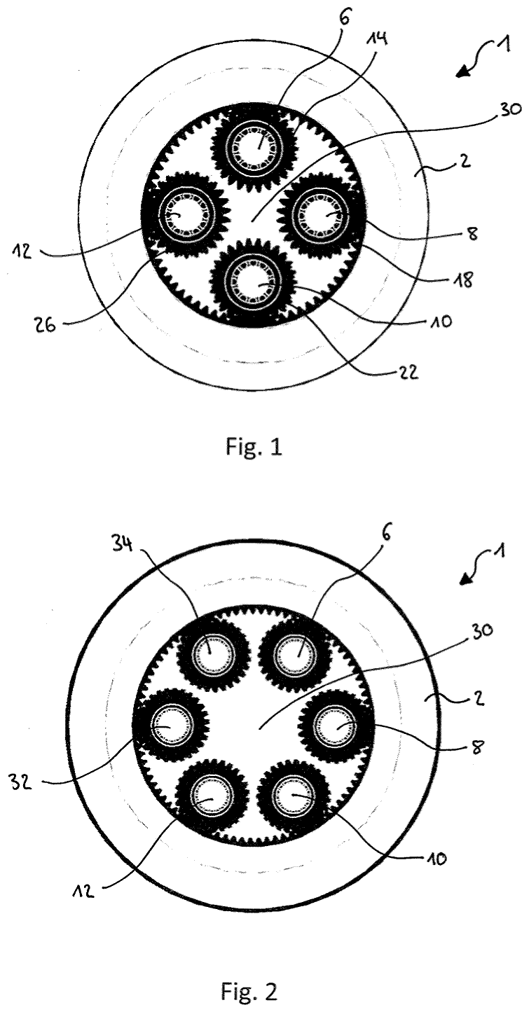

FIG. 1: shows a plan view of a first embodiment of a planetary gear unit;

FIG. 2: shows a plan view of a second embodiment of a planetary gear unit;

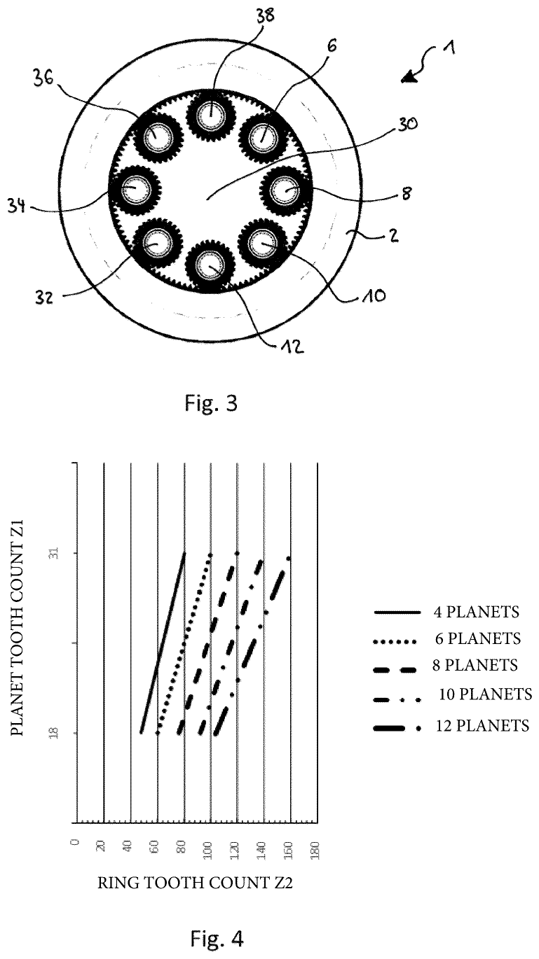

FIG. 3: shows a plan view of a third embodiment of a planetary gear unit;

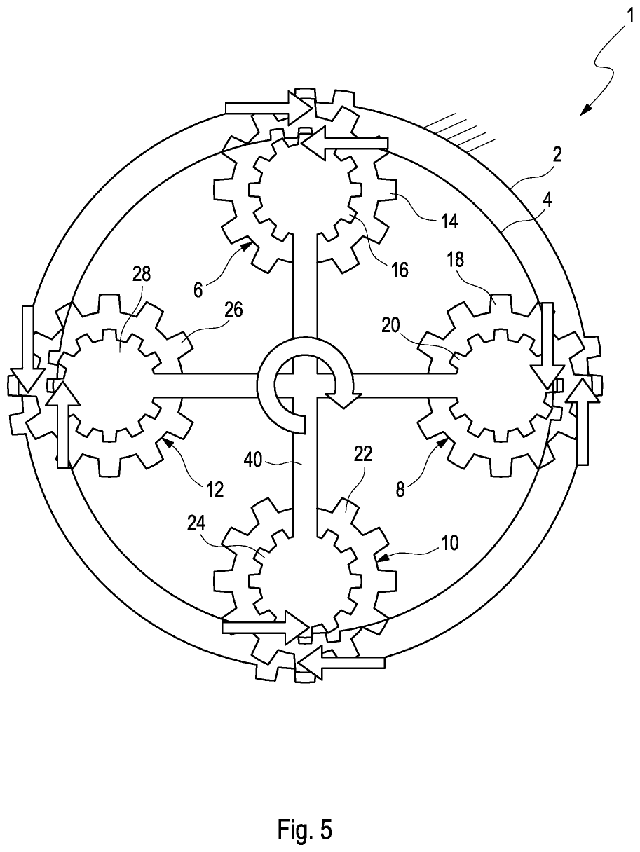

FIG. 4: shows a diagram illustrating a ratio of the tooth count of the ring gears and double planets for different numbers of double planets in the planetary gear units of FIGS. 1 to 3;

FIG. 5: shows a plan view of the planetary gear unit of FIG. 1 according to a first variant of a preload in the planetary gear unit;

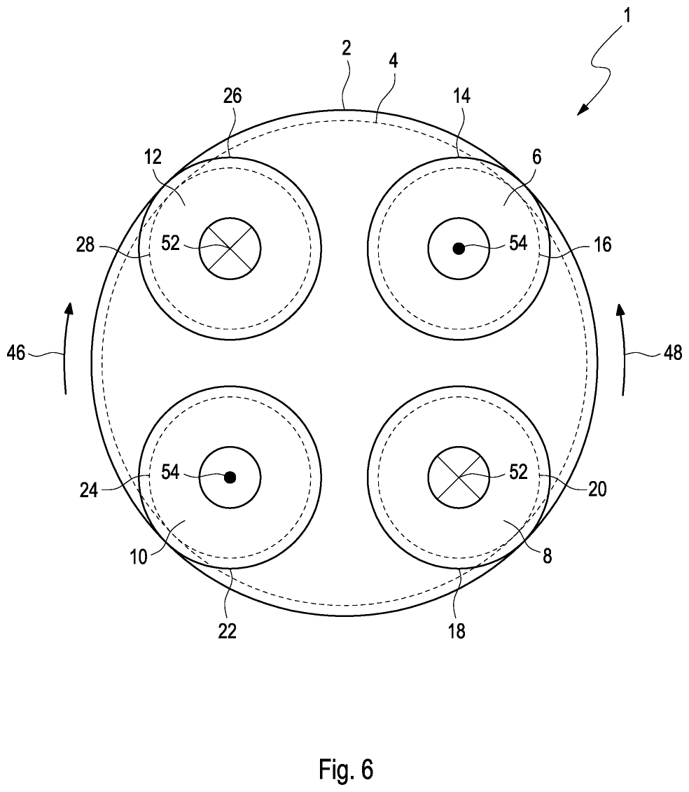

FIG. 6: shows a plan view of the planetary gear unit of FIG. 1 according to a second variant of a preload in the planetary gear unit; and

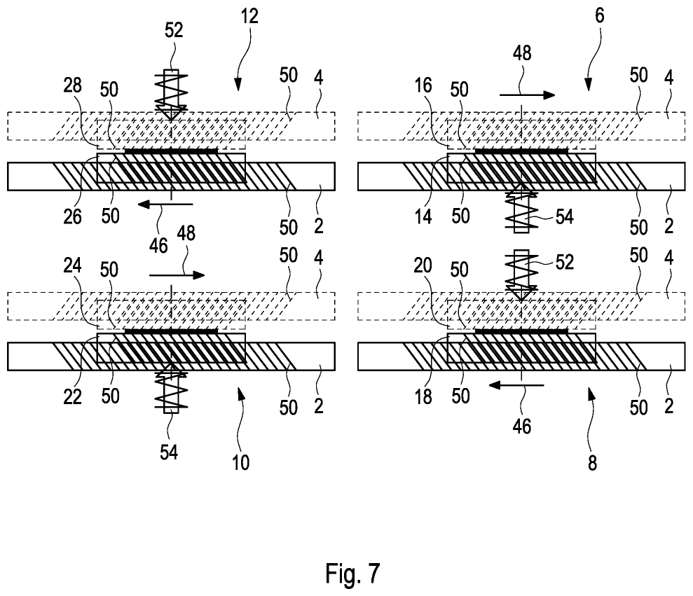

FIG. 7: shows a sectional view of the planetary gear unit of FIG. 6.

Identical or functionally equivalent elements are denoted by the same reference signs hereinbelow.

FIG. 1 shows a planetary gear unit 1 which has a first ring gear 2 and a second ring gear (not shown in FIG. 1). The planetary gear unit 1 furthermore has a first double planet 6, a second double planet 8, a third double planet 10, and a fourth double planet 12.

The double planets 6, 8, 10, 12 have in each case two gear wheels, wherein only the first gear wheel 14, 18, 22, 26 can in each case be seen in FIG. 1. The first gear wheels 14, 18, 22, 26 herein are in contact with the first ring gear 2, and the second gear wheels are in contact with the second ring gear.

In order to now enable cables, wires, tubes and similar to be fed through the planetary gear unit 1, the number and size of the double planets 6, 8, 10, 12 are adapted in such a way that a predetermined size of an interior space 30 of the planetary gear unit 1 is provided. This means that the double planets 6, 8, 10, 12 are selected in such a way that cables, etc. can be fed through the interior space 30 of the planetary gear unit 1. The number and size of the double planets 6, 8, 10, 12 is in particular adapted in such a way that a high torsional stiffness and/or load-bearing capability of the planetary gear unit 1 and at the same time sufficient space for feeding through cables, wires and similar is provided.

If more space is required for feeding through cables and similar, the interior space 30 can be enlarged in that more double planets 6, 8, 10, 12 which have the same size, or tooth count×module, respectively, are used. As is shown in FIGS. 2 and 3, the number of double planets can be increased for example to six (FIG. 2) or eight (FIG. 3). If six double planets 6, 8, 10, 12, 32, 34 are used, the interior space already becomes larger. If eight double planets 6, 8, 10, 12, 32, 34, 36, 38, the interior space becomes even larger. The size, or tooth count×module, respectively, of the ring gears 2 is accordingly likewise increased. The same double planets 6, 8, 10, 12, 32, 34, 36, 38 can thus be used in all three variants shown of the planetary gear unit 1 in FIGS. 1 to 3, as a result of which the external circumference is then correspondingly enlarged.

If the external circumference of the planetary gear unit 1 is restricted by the available space in the application in which the planetary gear unit 1 is used, smaller double planets 6, 8, 10, 12, 32, 34, 36, 38 can alternatively be used so as to nevertheless keep the interior space 30 to a predetermined size. The selection of the size and number of double planets 6, 8, 10, 12, 32, 34, 36, 38 can take place based on a desired torsional stiffness, load-bearing capability and interior space size, as already explained.

In order to optimize the torsional stiffness, load-bearing capability and interior space size, a specific number of double planets can be used as a function of their size, likewise defined by the diameter (tooth count×module), for a specific size of the ring gears, which is defined by the ring gear diameter (tooth count×module). Possible ratios of the ring gear diameters to the double planet diameters for different numbers of double planets are illustrated in FIG. 4. Here, the ring gear tooth count z2 is illustrated on the x-axis, and the planet tooth count z1 is illustrated on the y-axis.

As can be derived from FIG. 4, for example when using four double planets in a planetary gear unit (solid line), these four double planets can in each case be utilized with a diameter of at least 18 teeth×module and with a ring gear diameter of at least 48 teeth×module. If the ring gear diameter is increased to at least 60 teeth×module, the number of double planets can be increased by two to six without increasing the diameter of the double planets.

A larger number of double planets 6, 8, 10, 12, 32, 34, 36, 38 can likewise be used. A number of double planets 6, 8, 10, 12, 32, 34, 36, 38 which is a multiple of two is preferably always provided. As a result of such a number of double planets, a particularly good distribution of force and reduction in play between the toothings of the ring gears 2, 4 and the toothings of the double planets 6, 8, 10, 12, 32, 34, 36, 38 can take place, as will be described hereunder with reference to FIGS. 5 to 7. Four double planets 6, 8, 10, 12 are in each case present in these figures. However, the same principles can also be applied to planetary gear unit 1 with six, eight, ten, . . . , double planets.

A first variant of play reduction is described in FIG. 5. In the embodiment shown here, the double planets 6, 8, 10, 12 are connected to one another by way of a planet carrier 40. In order to enable a feedthrough of cables and similar, the planet carrier 40 can have a passage opening (not shown).

In the embodiment shown in FIG. 5, the first ring gear 2 is larger than the second ring gear 4. Furthermore, the first ring gear 2 is fixed, wherein the planet carrier 40 acts as a drive, which rotates in the direction of the arrow, and the second ring gear 4 acts as an output. Other design embodiments and size ratios of the ring gears 2, 4 and double planets 6, 8, 10, 12 are likewise possible.

The double planets 6, 8, 10, 12 have in each case two gear wheels 14, 16 (first double planet 6), 18, 20 (second double planet 8), 22, 24 (third double planet 10), 26, 28 (fourth double planet 12). The first gear wheels 14, 18, 22, 26 herein are in contact with the first ring gear 2, and the second gear wheels 16, 20, 24, 28 are in contact with the second ring gear 4.

In order to prevent any play between the toothings of the gear wheels 14, 16, 18, 20, 22, 24, 26, 28 and the ring gears 2, 4, the gear wheels 14, 16, 18, 20, 22, 24, 26, 28 of all double planets 6, 8, 10, 12 are preloaded. For this purpose, the first gear wheel 14 of the first double planet 6 is preloaded in the clockwise direction in relation to the toothing of the first ring gear 2, as is indicated by the arrow. The second gear wheel 16 of the first double planet 6 is preloaded in the counter-clockwise direction in relation to the toothing of the second ring gear 4, as is likewise indicated by an arrow.

In a mirror image, the first gear wheel 20 of the second double planet 8 is preloaded in the counter-clockwise direction in relation to the toothing of the first ring gear 2, as is indicated by the arrow. At the same time, the second gear wheel 22 of the second double planet 8 is preloaded in the clockwise direction in relation to the toothing of the second ring gear 4, as is indicated by the arrow.

This is likewise carried out for the double planets 10, 12: the first gear wheel 22 of the third double planet 10 is preloaded in the clockwise direction in relation to the toothing of the first ring gear 2, as is indicated by the arrow. The second gear wheel 24 of the third double planet 10 is preloaded in the counter-clockwise direction in relation to the toothing of the second ring gear 4, as is likewise indicated by an arrow. In a mirror image, the first gear wheel 26 of the fourth double planet 12 is preloaded in the counter-clockwise direction in relation to the toothing of the first ring gear 2, as is indicated by the arrow. At the same time, the second gear wheel 28 of the fourth double planet 8 is preloaded in the clockwise direction in relation to the toothing of the second ring gear 4, as is indicated by the arrow.

In this way, the double planets 6, 8, 10, 12 are alternately preloaded in a diametrically opposed manner. This leads to the preload being uniformly distributed circumferentially and any play between the gear wheels 14, 16, 18, 20, 22, 24, 26, 28 and the ring gears 2, 4, which would have a damaging effect on the planetary gear unit 1 during operation, being prevented.

Another variant for reducing play is shown in FIGS. 6 and 7. In the embodiment shown in FIG. 6, the first ring gear 2 is larger than the second ring gear 4. The first ring gear 2 can act as a drive, and the second ring gear 4 can act as an output. Other embodiments and proportions of the ring gears 2, 4 and of the double planets 6, 8, 10, 12 are also possible.

As also in the embodiment shown in FIG. 5, the double planets 6, 8, 10, 12 have in each case two gear wheels 14, 16; 18, 20; 22, 24; 26, 28. The first gear wheels 14, 18, 22, 26 are in contact with the first ring gear 2, and the second gear wheels 16, 20, 24, 28 are in contact with the second ring gear 4. Due to this contact between the double planets 6, 8, 10, 12 and the ring gears 2, 4, a movement of the first ring gear 2 in a first rotation direction 46 or a second rotation direction 48 is transmitted to the second ring gear 4, and vice versa. The rotation directions 46, 48 of the ring gears 2, 4 are indicated by arrows 46, 48 in the figures.

FIG. 7 shows sectional views of each double planet 6, 8, 10, 12 in combination with the ring gears 2, 4. As can be seen in FIG. 7, the ring gears 2, 4 and the double planets 6, 8, 10, 12 have in each case a helical toothing 50. Each helical toothing 50 has a first tooth flank and a second tooth flank which is opposed to the first tooth flank. A surface normal of the first tooth flanks is directed in the first rotation direction 46 of the first and of the second ring gear 2, 4, and a surface normal of the second tooth flanks is directed in the second rotation direction 48 of the ring gears 2, 4.

When the wheels (the ring gears 2, 4 and thus also the gear wheels 14, 16; 18, 20; 22, 24; 26, 28 of the double planets 6, 8, 10, 12) change their rotation direction 46, 48, i.e. perform a forward and backward movement and/or perform an oscillating movement between the two rotation directions, play in the toothing between the toothings 50 can cause a non-uniform motion profile of the wheels.

In order to minimize the play in the toothing between the helical toothings 50 of the gear wheels 14, 16; 18, 20; 22, 24; 26, 28 of the double planets 6, 8, 10, 12 and of the ring gears 2, 4, one or a plurality of force-exerting elements 52, 54 are therefore provided in this variant. A first force-exerting element 52 exerts a first force in a first direction, and a second force-exerting element 54 exerts a second force in a second direction which is opposite the first direction. The first direction and the second direction are perpendicular to the first and the second rotation direction 46, 48.

In the embodiment shown in FIGS. 6 and 7, the first force is exerted on the first and the fourth double planet 6, 12, and the second force is exerted on the second and the third double planet 8, 10. Due to the first force, the first tooth flanks of the helical toothings 50 of the first gear wheels 14, 26 of the first and of the fourth double planet 6, 12 are in contact with the second tooth flanks of the helical toothing of the first ring gear 2. Additionally, the second tooth flanks of the helical toothings 50 of the second gear wheels 16, 28 of the first and of the fourth double planet 6, 12 are in contact with the first tooth flanks of the helical toothing of the second ring gear 4. Owing to this contact, a preload on the ring gears 2, 4 in the first rotation direction 46 is provided.

Additionally, due to the second force, the second tooth flanks of the helical toothings 50 of the first gear wheels 18, 22 of the second and of the third double planet 8, 10 are in contact with the first tooth flanks of the helical toothing of the first ring gear 2. Additionally, the first tooth flanks of the helical toothings 50 of the second gear wheels 20, 24 of the second and of the third double planet 8, 10 are in contact with the second tooth flanks of the helical toothing of the second ring gear 4. Owing to this contact, a preload on the ring gears 2, 4 in the second rotation direction 48 is provided.

Owing to the fact that the first and the fourth double planet 6, 12 are pushed in the direction of the first ring gear 2, the helical toothings 50 of the first and of the fourth double planet 6, 12 are in contact with the helical toothings of the first and of the second ring gear 2, 4. Owing to the fact that the second and the third double planet 8, 10 are pushed in the direction of the second ring gear 4, the helical toothings 50 of the second and of the third double planet 8, 10 are in contact with the helical toothings of the first and of the second ring gear 2, 4.

Due to this preload, there is contact between the helical toothings 50 of the ring gears 2, 4 and the helical toothings 50 of the gear wheels 14, 16; 18, 20; 22, 24; 26, 28 of the double planets 6, 8, 10, 12 already during start-up. Additionally, this contact can be maintained during operation by means of the force-exerting elements 52, 54 in that the preload is maintained, and play in the toothing between the helical toothings 50 can be avoided in this way.

The force-exerting elements 52, 54 can be implemented, for example, as springs, magnetic elements, hydraulic elements, or any other type of element which is capable of exerting a force on the double planets 6, 8, 10, 12. This force could also be generated by a different toothing angle between the ring gears 2 and 4. The total amount of the first force, which is exerted by the first force-exerting elements 52, and the total amount of the second force, which is exerted by the second force-exerting elements 54, are preferably the same.

By way of the planetary gear unit described above, it is thus possible to optimize the number and size of the double planets in terms of the required interior space, under certain circumstances while taking into account the dimensions of the ring gear, a predetermined torsional stiffness and/or load-bearing capability. Furthermore, any play in the toothing between the ring gears and the double planets can be avoided.

### LIST OF REFERENCE SIGNS

1 Planetary gear unit
2 First ring gear
4 Second ring gear
6 First double planet
8 Second double planet
10 Third double planet
12 Fourth double planet
14 First gear wheel of the first double planet
16 Second gear wheel of the first double planet
18 First gear wheel of the second double planet
20 Second gear wheel of the second double planet
22 First gear wheel of the third double planet
Second gear wheel of the third double planet 24
26 First gear wheel of the fourth double planet
28 Second gear wheel of the fourth double planet
30 Interior space
32 Fifth double planet
34 Sixth double planet
36 Seventh double planet
38 Eighth double planet
40 Planet carrier
46 First rotation direction
48 Second rotation direction
50 Helical toothing
52 First force-exerting element
54 Second force-exerting element

1. A planetary gear unit comprising:
a first ring gear having toothing and a second ring gear having toothing, and
at least four double planets each having a first gear wheel having toothing and a second gear wheel having toothing, the first gear wheel and the second gear wheel of each double planet being disposed so as to be rotatable about a common shaft,
wherein the toothing of each first gear wheel engages in the toothing of the first ring gear, and the toothing of the each second gear wheel engages in the toothing of the second ring gear, and
wherein a number and a size of the double planets is selected such that a predetermined size of an interior space in a center of the planetary gear unit, a predetermined torsional stiffness of the planetary gear unit and/or a predetermined load-bearing capability of the planetary gear unit is provided.

2. The planetary gear unit according to claim 1,
wherein the number and the size of the double planets selected such that the predetermined torsional stiffness and/or the predetermined load-bearing capability are/is maximized and an external diameter of the ring gears is minimized.

3. The planetary gear unit according to claim 1,
wherein a tube is disposed in the interior space.

4. The planetary gear unit according to claim 1,
wherein a first double planet and a second double planet of the at least four double planets are disposed adjacent to each other and in such a way that the first gear wheel of the first double planet is preloaded in a first rotation direction and the second gear wheel of the first double planet is preloaded in a second rotation direction opposite the first rotation direction and in such a way that the first gear wheel of the second double planet is preloaded in the second rotation direction and the second gear wheel of the second double planet is preloaded in the first rotation direction.

5. The planetary gear unit according to claim 1,
wherein a first double planet and a second double planet of the at least four double planets are preloaded in opposite directions.

6. The planetary gear unit according to claim 5,
wherein the first gear wheel and the second gear wheel of each of the at least four double planets are fixed relative to one another.

7. The planetary gear unit according to claim 1, wherein the toothing of the first ring gear is helical and the toothing of the second ring gear is helical,
wherein the first ring gear is configured to rotate in a first rotation direction and the second ring gear is configured to rotate in a second rotation direction,
wherein the toothings of the first gear wheel and of the second gear wheel of each of the at least four double planets are helical toothings,
wherein each helical toothing has a first tooth flank and a second tooth flank opposite the first tooth flank,
wherein a surface normal of the first tooth flank is directed in the first rotation direction and a surface normal of the second tooth flank is directed in the second rotation direction,
wherein a first double planet and a second double planet of the at least four double planets are disposed adjacent to each other and such that a first force-exerting element exerts a first force to press the first tooth flanks of the first gear wheel of the first double planet against the second tooth flanks of the first ring gear, and to press the second tooth flanks of the second gear wheel the first double planet against the first tooth flanks of the second ring gear to preload the ring gears in the first and the second rotation direction, and
such that a second force-exerting element exerts a second force opposite the first force to press the second tooth flanks of the first gear wheel of the second double planet against the first tooth flanks of the first ring gear, and to press the first tooth flanks of the second gear wheel of the second double planet against the second tooth flanks of the second ring gear to preload the ring gears in the first and the second rotation direction.

8. The planetary gear unit according to claim 1, wherein a first half of the at least four double planets is preloaded in the first rotation direction, and wherein a second half of the at least four double planets is preloaded in the second rotation direction, and wherein the first half and the second half of the double planets are alternately disposed.

9. The planetary gear unit according to claim 1,
wherein the at least four double planets comprise an even number of double planets.

10. The planetary gear unit according to the at least four double planets comprise at least six double planets.

11. The planetary gear unit according to claim 1,
wherein a ratio of an interior diameter of the first ring gear and the second ring gear to the number and the size of the double planets is selected such that the predetermined torsional stiffness and/or the predetermined load-bearing capability are/is maximized and an external diameter of the ring gears is minimized.
